(19) United States
(12) Patent Application Publication
(10) Pub. No.: US 2011/0197144 A1
(43) Pub. Date: Aug. 11, 2011

(54) Method And System Of Providing A Viewing Experience With Respect To A Document Having Read-only Content

(76) Inventors: Terry Coatta, Richmond (CA); Cristian George Constantin, Burnaby (CA); Grant Burnard, Grand Forks (CA)

(21) Appl. No.: 12/986,159

(22) Filed: Jan. 6, 2011

Related U.S. Application Data
(60) Provisional application No. 61/292,691, filed on Jan. 6, 2010.

(51) Int. Cl. G06F 3/00

(52) U.S. Cl. 715/749

(57) ABSTRACT

Computer-implemented methods of and systems for providing a viewing experience to a user are disclosed. In one such method, an electronic document is provided. The electronic document has read-only content and embedded executable code which executes upon opening the document. The executable code influences a viewing experience. A remote database having data about a user is provided and data is received from the database for use in conjunction with the embedded executable code in order to provide a viewing experience to the user.

### CROSS-REFERENCE TO RELATED APPLICATION

This application claims the benefit of priority to U.S. provisional patent application Ser. No. 61/292,691, filed on Jan. 6, 2010.

### FIELD OF THE INVENTION

The invention pertains to methods and systems of displaying a document to a user via a computer and its associated monitor.

### BACKGROUND OF THE INVENTION

Authors of electronic documents have the ability to distribute their work in such a way that the reader is unable to modify the text, layout and other aspects of a viewing experience associated with the document. Such documents are said to have content which is “read-only”. Although desirable from a consistency standpoint, there exists a need to provide electronic documents having read-only content in a manner that provides a viewing experience that takes into account the user that is viewing the electronic document, and thereby provides a contextually sensitive viewing experience to the user of the document. Currently, it is very difficult to provide such a tailored viewing experience for an electronic document having read-only content, and it is even more difficult to modify that viewing experience as the user interacts with the document.

U.S. Pat. No. 7,210,039 B2 issued to Rodgers et al. describes an invention related to digital rights management and more particularly to a system and method for securely publishing and controlling the usage of digital content. Advantageously a publisher or owner of digital content or of a copyright work can distribute securely that work in a secure digital form. Although this piece of prior art describes making alterations to a read-only electronic document based on a response from a server, the viewing experience remains unchanged. In addition, in Rodgers et al. there is no collection of context information and delivery of that information to a remote system.

U.S. Pat. No. 6,138,155 issued to Davis et al. describes a method of monitoring client interaction with a resource downloaded from a server in a computer network. This method includes the steps of using a client to specify an address of a resource located on a first server, downloading a file corresponding to the resource from the first server in response to specification of the address, using the client to specify an address of a first executable program located on a second server, the address of the first executable program being embedded in the file downloaded from the first server, the first executable program including a software timer for monitoring the amount of time the client spends interacting with and displaying the file downloaded from the first server, downloading the first executable program from the second server to run on the client so as to determine the amount of time the client interacts with the file downloaded from the first server, using a server to acquire client identifying indicia from the client, and uploading the amount of time determined by the first executable program to a third server. The first executable program may also monitor time, keyboard events, mouse events, and the like, in order to track choices and selections made by a user in the file, and may execute upon the occurrence of a predetermined event, as well as monitoring or determining the amount of information downloaded by the client. Although Davis et al. describes an interaction between a server and a document, the communication between them is only made in one direction. Specifically, the document sends user data to the server, but the document itself is not modified based on data residing on the server.

U.S. Pat. No. 7,356,537 issued to Reynar et al. describes a method and system for creation, implementation, and use of computer-generated “smart” documents to which functionality is attached for providing contextually sensitive tools, controls and help content to users of those documents. Portions of documents are annotated with Extensible Markup Language (XML) tags and structure so that when a user enters those portions, such as by placing a computer cursor in those portions, the user is provided contextually sensitive tools, controls and/or help content. A document tools pane may open on the user's computer screen adjacent to the document being edited for providing the document tools, controls or help content related to the context of the text or data in which the cursor is located. If the user moves the cursor to another portion of the document, the user may obtain information associated with the context of the new portion of the document in which the cursor is located. Reynar et al. describes a document that contains additional functionality based on the actions of the user. However, the functionality is not personalized for each user, nor does it record context information for future use.

Therefore, because of these deficiencies in the prior art, there exists a demand for a system and method in which an electronic document having read-only content is provided to a user in a manner that is tailored to that particular user in order to provide a more valuable viewing experience to the user. In this manner, the viewing experience may be personalized and the information provided by the user may be more useful. Furthermore, there exists a demand for a system or method capable of making these alterations in real-time to avoid the time-consuming process of creating and distributing personalized documents.

### SUMMARY OF THE INVENTION

The invention may be embodied as a method of providing a contextually sensitive viewing experience to a user of a document. In one such method, an electronic document having read-only content is provided. The electronic document has embedded executable code, which executes upon opening the document. The executable code influences a viewing experience, for example when the document is viewed on a computer monitor, provided to the user that may be modified based on data provided by a remote database.

A remote database has data regarding the user, and that data may be provided to the embedded executable code. Additional executable code in the database may be provided and used in conjunction with the data as well. The data may be downloaded to and used by the embedded executable code to influence a viewing experience provided to the user, for example via a computer monitor. When the document is opened, the embedded executable code is executed, and in conjunction with the data received from the remote database, a viewing experience is provided to the user. The viewing experience afforded to the user may be altered using the data in conjunction with the embedded executable code and any additional executable code provided from the database.

The invention may be embodied as a system having a remote database, an electronic document with read-only content and embedded executable code, and a communications channel between the electronic document and the remote database. In one such system, the remote database has data about users. The remote database may also include additional executable code. The embedded executable code may execute upon opening the document. The embedded executable code contributes to providing a viewing experience using data and any additional executable code from the database. The communications channel between the electronic document and the remote database is capable of transmitting the data and any additional executable code from the database to the document for use in conjunction with the embedded executable code.

### BRIEF DESCRIPTION OF THE DRAWINGS

For a fuller understanding of the nature and objects of the invention, reference should be made to the accompanying drawings and the subsequent description. Briefly, the drawings are:

FIG. 1 is a flow chart depicting aspects of a method that is in keeping with the invention.

FIG. 2 is a schematic diagram of a system that is in keeping with the invention.

FIG. 3 is schematic diagram of a system that is in keeping with the invention.

### DETAILED DESCRIPTION OF THE INVENTION

An entity that provides content via one or more types of electronic documents may want to interact with the individual that is reading the document. For example, the document provider may want to collect information about who is reading the document. In addition, the document provider may want to respond to the reader based on the reader's previous history with that particular document, or other media from the provider.

For example, when a user first reads a document D₁ from the provider, that document may be used to collect certain contact information from the user using an input mechanism. Such information may include the user's email address or business telephone number. If the user then accesses a second document D₂ from that provider, it does not make sense to collect that same contact information from the user again. Instead, it may be desirable to collect information about the particular products the user is interested in, or whether the provider's documents deliver information that the user requires.

Consider a second example in which a different user accesses those same two documents, but in the reverse order—the user reads document D₂ before reading document D₁. In this case, document D₂ should serve the function that document D₁ served in the scenario described above. That is, document D₂ should be used to obtain business contact information, rather than to collect information about products or utility of the documents. The manner in which a particular document is used to interact with the user may be dependent on which documents the user previously accessed, and/or may be dependent on information previously collected from the user.

Consider a third example in which the interaction with the user extends beyond simply collecting information from the user, and instead provides something to the user based on the user's previous activities. For example, a document provider could have a set of sales brochures that it makes available as PDF documents. After the user has accessed three different sales brochures, the media provider may like to display a real time chat widget to the user that will directly connect the user with a sales agent, and this may be accomplished using additional executable code from the remote database. Like the situations described above, use of context information controls when the chat widget is displayed to the user.

A system and method according to the invention described herein may provide a means to address the document provider's need to (1) tailor the type of information provided to a user, and (2) tailor the document provider's response to the user. This need may be accomplished using executable code embedded in the document used in conjunction with data about the user that is provided by the remote database. By coupling executable code within the electronic document with a well-known set of data, the viewing experience can be manipulated in a manner that is helpful to the user, the document provider, or both.

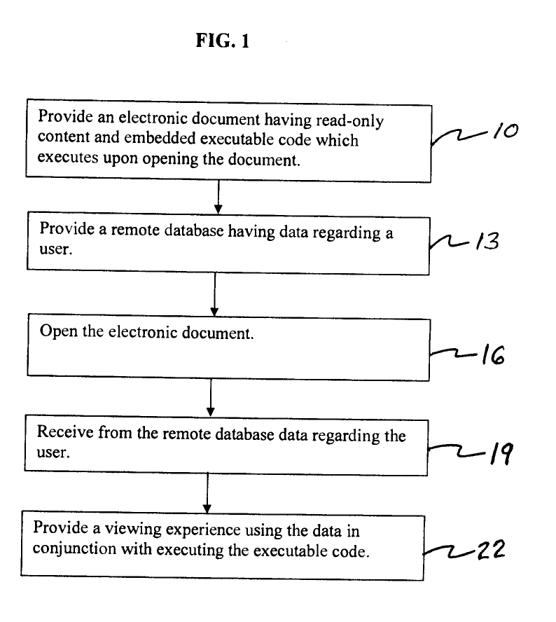

FIG. 1 is a flow diagram showing features of a method that is in keeping with the invention. The computer-implemented method depicted in FIG. 1 provides a viewing experience to a user such that an electronic document having read-only content is provided 10 to the user's computer and ultimately rendered viewable 22 to the user via an associated monitor. A particular type of exchange format for read-only content that is popular is the Portable Document Format standard, and content that is in keeping with this standard is normally referred to as “PDF” content. The electronic document has embedded executable code which executes upon opening the document. The executable code may be used to provide and modify the viewing experience of the user. For example, the viewing experience may be modified to tailor the information provided to the user to that user's particular interests. For example, the viewing experience might be modified by adding content, removing content, altering content, pre-populating fields, and personalizing content.

A remote database that is located away from the user's computer is provided 13. The remote database includes data regarding the user and may also include additional executable code, either or both of which may be provided to the embedded executable code. The embedded executable code and any additional executable code may be Javascript® code, Flash® code, or any executable code format that is supported by the document format used to deliver the document, or a combination of such formats. In use, the user may provide an instruction to open 16 the electronic document, data from the database is provided and received 19, and thereafter the embedded executable code is executed to provide 22 a viewing experience that is based on the data in conjunction with the embedded executable code. Additional executable code from the database may be selected, provided, received and executed in conjunction with the embedded executable code. Selection of the additional executable code may be made using data in the remote database, and in this manner the additional executable code that is provided may be better tailored to the needs and interests of the user.

Data from the remote database may be received 19 and used in combination with executing 22 the embedded executable code and (if provided) the additional executable code. The data about the user from the database may be received and stored in a local memory that is associated with the computer that is directly controlling the monitor that is providing the viewing experience directly to the user. By providing and using the data from the database and any additional executable code provided, the user may be provided with the document (or portions thereof) in a manner that is tailored to the needs and/or interests of the user, or the perceived needs and/or interests of the user.

For example, the data received from the remote database may include information about preferences of the user. Such preferences might include preferences about text fonts, text size, text color, or line spacing. Such preferences might include preferences about types of food, favorite retail stores or hobbies of the user. With such information, the document and options associated with the document may be provided to the user in a manner that is helpful to the user. For example, the appearance of the electronic document may be altered from a default appearance to an appearance which is believed to be tailored to the user's preferences. In this manner, the viewing experience is provided 22 according to the data and any additional executable code in conjunction with the embedded executable code. The data provided by the remote database may include actions taken by a user with respect to the document currently being viewed or actions taken by the user with respect to a different document.

The electronic document may have a user input mechanism which allows the user to provide information. For example, the user input mechanism may be a modal window that is capable of receiving input from the user. An interactive program module may be used to prompt the user for input, perhaps via a viewing window that is displayed over a portion of the document being displayed to the user via a monitor. The interactive module may communicate the user's input to the remote database, where the user's input may be stored and possibly used later.

The input from the user may be provided to the database, and used to update or augment the data in the database. The input mechanism may include a plurality of selectively editable fields to allow the user flexibility in identifying information to be provided to the database for later use as data, or used as data in conjunction with the current activities of the user. Further, information provided via the input mechanism may be used without being provided to the database, but nevertheless used in conjunction with the embedded executable code and/or additional executable code to enhance the user's viewing experience with respect to the electronic document.

The executable code may collect information about the user, and such information may be used to modify the current viewing experience or a later viewing experience. The information collected may include the context in which the information was gathered. For example, the collected information may include an identification of the user, information about web sites visited while the document is displayed, the geographic location of the user, the time that the document is provided for viewing by the user, time spent by the user viewing each page or section of the document, where the user's mouse was moved while viewing the document, or which pages of the document were printed by the user.

The collected information may include an identifier that is associated with the user in order that the information may be easily correlated and retrieved for use with that user. The collected information may include an identifier associated with and identifying an electronic document or type of document. If both the user identifier and the document identifier are used together, the collected data may be more useful in providing a particular type of viewing experience to the user that is believed to be beneficial to the user.

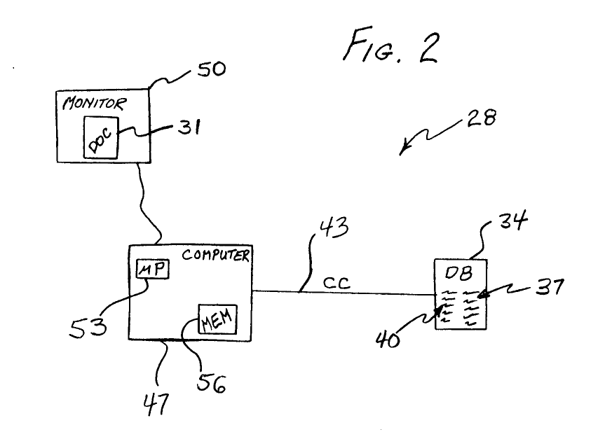

FIG. 2 depicts a system 28 that may be used to carry out a method according to the invention. FIG. 2 shows a graphical representation 31 of an electronic document with read-only content and embedded executable code which executes upon opening the document, a remote database 34 having data 37 regarding the user and may also have additional executable code 40, and a communications channel 43 between the electronic document and the remote database 34. The electronic document may include content that is in PDF.

The embedded executable code and/or the additional executable code 40 may be in a popular programming language such as Javascript® code or Flash® code, but the executable code may be in another language. The executable code may be executed by the local computer 47 to cause the computer 47 to provide an aspect of the viewing experience via the monitor 50, or the entire viewing experience. The local computer 47 may include a microprocessor 53 and a memory 56. The hierarchy of the executable codes may be made so that conflicting instructions arising from execution of the additional executable code and the embedded executable code are resolved by selecting the instructions of the additional executable code. In a similar manner, the hierarchy between data 37 from the remote database 34 and information provided by the user (but not yet sent to the database 34) may be such that data 37 from the database 34 is used in lieu of conflicting information, but when there is no conflict between data 37 from the database 34 and locally stored information not yet provided to the database 34, then both the data 37 and the information may be used in conjunction with the executable code to provide the viewing experience. In this manner, the system 28 may be made to prefer the use of data 37 and additional executable code 40 from the database 34, but when the database 34 is not available or the communications channel 43 is not operating properly, then the embedded executable code and information stored locally may be used to provide a tailored viewing experience to the user.

The communications channel 43 is capable of transmitting the data 37 and the additional executable code 40 from the database 34 to the document, and the executable code provides instructions to the local computer 47, which directly controls a viewing experience provided to the user via the monitor 50 using the data 37 and the additional executable code 40 from the database 34. The communications channel 43 may be capable of transmitting information about the user that is collected during a current viewing experience to the remote database 34 for storage, and use at a later time. The information stored locally and the data 37 in the database 34 may include details about actions taken by the user with respect to the electronic document currently being provided via the monitor 50, or actions taken by the user with respect to a document previously provided via the monitor 50.

The electronic document also may have a user input mechanism. The user input mechanism may be used to allow the user to provide information, which may be provided via the communications channel 43 to the remote database 34, and/or stored on the local memory 56 associated with the computer 47 that is directly responsible for controlling the monitor 50 that is providing the viewing experience to the user. The information provided by the user via the input mechanism may be used to determine features of the viewing experience provided to the user via the monitor 50. The input mechanism may be a modal window that is capable of receiving input from the user. The user input mechanism may include a plurality of selectively editable fields.

The embedded executable code and any additional executable code 40 may be responsible at least in part for providing the input mechanism, and thereby may serve to collect information about the user. However, the embedded executable code and any additional executable code 40 may collect information about the user without the user's knowledge. The information about the user that is collected during a current viewing experience, or the data 37 provided by the database 34 via the communications channel 43 may be used by the executable code to control a viewing experience and thereby provide a viewing experience that is tailored to the user.

Some of the information that may be provided by the user via the input mechanism may be used to identify the user. For example, a user name and/or password may be requested of the user so that that user's information and data may be utilized by the executable code to provide the viewing experience.

The information about the user that is gathered (and which ultimately may be provided to the database 13, where it would become “data” 37) may include information about the user's actions with respect to the document that is currently being displayed via the monitor 50. For example, such information may include the duration that a user has a particular paragraph of the document displayed on the monitor 50, or the pages printed by the user. With such information, it may be possible to predict the interests of the user, and provide the user with a viewing experience that takes into account those predicted interests. For example, if a paragraph in a document pertains to wind surfing on the Fraser River and the user displays that paragraph on the monitor 50 for a period of time that is longer than a threshold time period, then additional executable code and/or data 37 from the remote database 34 may be provided to the user's computer and used by the user's computer 47 to modify the viewing experience in order to offer the user information about lodging in Vancouver, British Columbia, and/or alter the appearance of the document 31 to be more in keeping with that which most wind surfers are believed to enjoy. For example, if it is believed that wind surfers enjoy reading documents that are in a dark blue and slightly italicized font, then the text of the document 31 may be altered and displayed in that color and font.

Information collected about a user may be transmitted via the communications channel 43, and the embedded executable code may play a role in sending the collected information to the remote database 34. The local memory device 56 may be part of the communications channel 43, and used to store information until such time as the information can be conveniently transmitted via the communications channel 43 to the database 34. Also, such a local memory may be used to store data from the remote database 34 until the executable code is ready to use the data 37.

Also, the executable code may be used to control how the document is altered based on the data 37, the information, and/or the additional executable code 40. For example, the embedded executable code may alter the viewing experience by providing an interactive module with which the user is asked to interact. The graphical user interface of such an interactive module may be a viewing window provided as an overlay to the document 31 that is displayed on the monitor 50. Via such an interactive module, the user may be asked to provide information that is ultimately sent to the remote database 34 via the communications channel 43 and/or stored locally in the memory 56. The interactive module may be made responsible for managing at least a portion of the tasks associated with communicating information to the database 34.

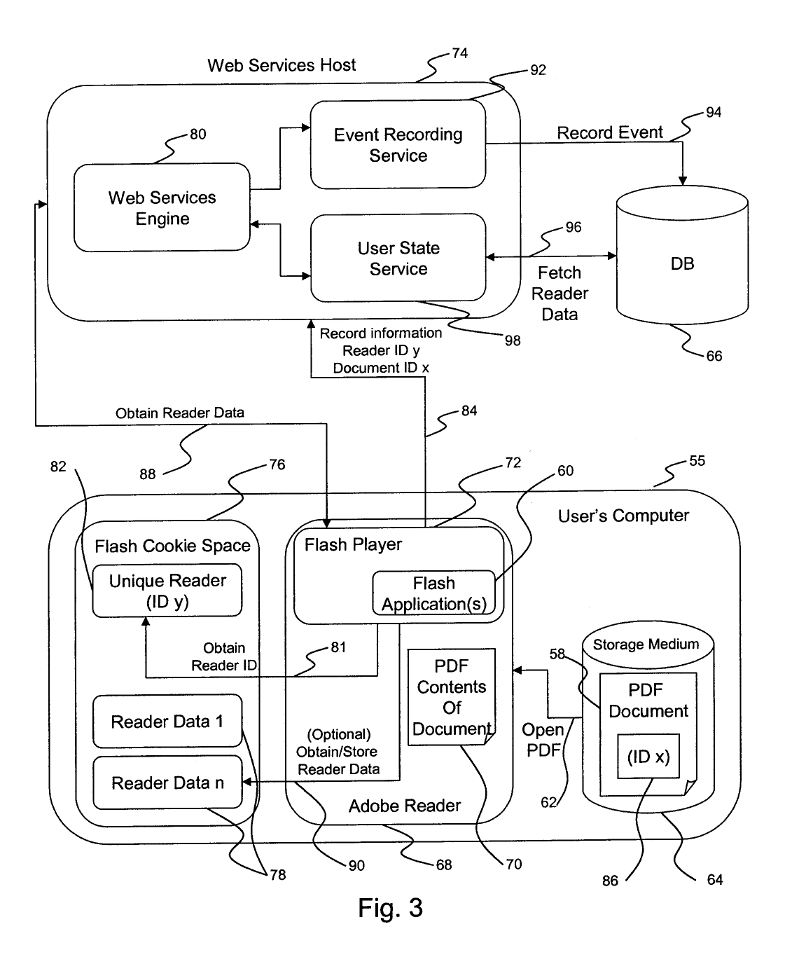

Having provided an overview of the invention, additional details will now be provided. FIG. 3 illustrates a system according to the invention, and coupled with the text that follows, a method according to the invention is also described. The embodiment illustrated in FIG. 3 allows for interaction with a user via the user's computer 55 and a document 58 having PDF read-only content. In such a system, particular interactions with the user are determined based on the user's patterns of interaction with the current document 58 and previously read documents. Such an embodiment may be implemented by embedding an executable application 60 within a document 58 that is provided to a user. When the user opens 62 the document 58 from the storage medium 64, the interactions of that application 60 with the user depend on context information related to the particular user that is accessing the document. For example, the document 58 may be a PDF document, and the executable application 60 placed in that document 58 may be a Flash® application.

However, the invention is not limited to this particular embodiment. In fact, the invention can be applied to many types of documents which allow executable applications 60 to be embedded within them, and which allow that executable application 60 to access a database 66, including those accessed via a network, such as the Internet.

As an example, PDF documents may include an executable applications 60 in the form of JavaScript® applications, and the invention applies to this scenario as well. In such an embodiment, certain capabilities of Adobe's Acrobat® and Reader® 68 products may be used. For example:
The ability to embed JavaScript® code within a PDF document. This JavaScript® code has access to the content of the PDF document 70 and can manipulate it in various ways.
The ability to embed Flash® applications within a PDF document. The execution of these Flash® applications can be controlled from JavaScript® code. In addition, there are mechanisms to allow the Flash® applications and the JavaScript® code to interact with one another. Finally, these Flash® applications can present a user interface to the user reading the document.

Although this invention is described herein as operating with Adobe Acrobat Reader® 68, other PDF viewing software that supports the PDF standard and the above noted specifications for JavaScript® and Flash® should allow for implementation of the invention.

Currently, the Flash® programming environment allows a Flash player 72 to provide:
Mechanisms to define objects, functions, procedures, and logical paths of execution.
Interacting with the user via windows, icons, buttons and other standard windowing components.
Interacting with other computer systems via a web services host 74.
   These may be useful in implementing the invention. There are two additional features of Flash® that are also useful.
The ability to load and execute a Flash® application 60 from a web services host 74. For example, a web page can embed a reference to a Flash® application that resides on a particular web services host 74. When a user views this page with their browser, the Flash® application 60 is loaded from that web services host 74.
The ability to store and retrieve data from a special type of local memory identified in FIG. 3 as “Cookie Space” 76. Cookies 78 allow different Flash® applications 60 to share data with each other as long as those Flash® applications 60 are loaded from the same web services host 74.

To further illustrate an embodiment of the invention that was identified above, consider the PDF document 58 which includes JavaScript® code and one or more Flash® applications 60 that will interact with the user who is reading the document 58 on the user's computer 55. The JavaScript® code which is embedded may establish certain predetermined JavaScript® triggers when the PDF document is opened. Certain JavaScript® functions may be called in response to events (“triggers”), such as a new page being displayed or the document 58 being printed. A JavaScript® function which is called in response to events is referred to herein as a “trigger function”. The purpose of such a trigger function may be to execute one or more Flash® applications 60 in response to a particular event. For example, a trigger function could be set in the PDF document 58 to call a particular Flash® application 60 when the user first accesses page six of the PDF document 58. It should be noted that in lieu of embedding a Flash® application 60 in the PDF document 58, a reference to a remote version of a Flash® application may be embedded in the PDF document 58, and in that instance, the reference is called by the trigger function.

A web services engine 80 or multiple engines for an embedded Flash® application 60 may allow the application to record information pertaining to the particular user, who is reading the document 58 on the user's computer 55. Also, web services engine 80 for that Flash® application 60 may request from a database 66 previously stored information pertaining to the particular user reading the document 58, so that the Flash® application 60 can react to one user differently from another user by using that information to decide between two or more alternatives that the application 60 may accomplish. Such services may be made available via a Flash® library (herein referred to as the “context library”) that may be called by the application 60.

In one embodiment of the invention, the specific application 60 embedded into the document 58 may display a data entry form for collecting information from the individual, who is reading the document. In this manner, the document is delivered to a user, and once the embedded Flash® application 60 is started, the Flash® application is able to execute, interact with the reader, and vary its behavior based on previous interactions with the user.

FIG. 3 also depicts the following activities:
The user opens 62 the PDF document 58 from a storage medium 64 on the user's computer 55. As the user navigates through the document or executes particular functions available via Adobe Reader® 68, the JavaScript® code is able to track what page the user is on and which activities the user has carried out. In one particular embodiment of the invention, the event handlers of the JavaScript® code tracks whether or not the user has printed the document and what page the user was on when the document was printed.
In response to a particular trigger, such as the user navigating to a particular page, a Flash® application 60 may be run. In one particular embodiment of the invention, the Flash® application 60 initializes the context services library, which in turn obtains the unique reader identification (“ID”) code 82 for the user accessing the PDF document 58. The unique reader ID 82 may be a GUID (Globally Unique Identifier). A GUID is a large number that can be generated in such a way that one GUID is virtually guaranteed to be different from a GUID generated on any other computer at any other time.
The unique reader ID 82 may be obtained by reading it from the Flash® cookie space 76. If the reader ID 82 does not exist within the cookie space 76, then a new reader ID 82 is allocated and stored in the cookie space 76. The reader ID 82 may be obtained in other ways. For example, some computer operating systems can provide an identifier which will meet the criteria required for the reader ID 82.
The reader ID 82 may uniquely identify the account on the user's computer 55 which is being used to access the document 58. In many cases, the reader ID 82 can uniquely identify the user reading the document 58.
Having obtained 81 the reader ID 82, the Flash® application 60 is then able to use the capabilities of the context services library to record or obtain information 84 about the activities of this particular user. In one embodiment, the context services library causes a web services host 74 to call a database 66, which is capable of storing arbitrary data and associating that data with the reader ID. In another embodiment, the web services engine 80 communicates the reader ID 82 and the document ID 86 to an event recording service 92 which communicates the information to database 66 in order to record 94 the event. In one embodiment of the invention, the context services library may store a unique document ID 86 for the document 58 being read and associate that with the reader ID 82. This allows the Flash® application 60 to determine whether the user has opened this particular document 58 previously. In addition, the information may be fetched 96 from the database 66 through the web services host 74 and sent back to the embedded application 60, and/or retrieved from cookies 78 in the Flash® cookie space 76 on the user's computer 68. The user state service 98 residing in the web services host 74 may determine what information is passed to the web services engine 80, and later to the Flash® application 60. The user state service 98 can base this determination on the recorded events 94. For example, the user state service 98 may pass information only if the reader ID 82 has been previously recorded in the database 66.
The context services library may store reader data in other locations. For example, the context services library may store reader data in the Flash® cookie space 76 in cookies 78. This has the advantage that the reader data would be available even when the user is reading the document 58 without an internet connection.
Having obtained 88 the reader data from the context services library, the Flash® application 60 is able to alter its behavior based on the data that it has obtained. For example, the Flash® application 60 could cause a different form of the document to be displayed to the user if they have printed the document 58.
The Flash® application 60 may also use the context services library 90 to store information. For example, the value that the user enters into a form could be stored via the context services library. Then, when the user subsequently opens the document 58, the Flash® application 60 could read the previous values from the form using the context services library and use them to pre-populate the form, or even to display an entirely different form based on the values entered into the original form.

The user context information can be associated with identifying information other than a unique GUID. For example, the user of the document 58 can be prompted for the email address and the context service would then retrieve 88 the user's context information based on the retrieved information.

There are a broad range of options that can be made possible through the capabilities embodied in the context services library coupled with the ability to embed arbitrary Flash® applications 60 into a PDF document 58. By enabling applications 60 to keep a historical record that is specific both a document 58 and the individual reading the document 58, it is possible to provide a personalized reading experience of the document 58 or to initiate business processes dependent on a reader's previous interactions with one or more documents.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A computer-implemented method of providing a viewing experience to a user, comprising the steps of:
providing an electronic document having read-only content, having embedded executable code which executes upon opening the document, and the executable code influences a viewing experience;
providing a remote database;
opening the electronic document;
receiving data regarding the user from the remote database; and
providing a viewing experience using the data in conjunction with the executable code.

2. The method of claim 1, wherein the data includes actions taken by a user with respect to the document.

3. The method of claim 1, wherein the data includes actions taken by a user with respect to another document.

4. The method of claim 1 further comprising:
receiving additional executable code from the remote database, and the viewing experience is provided using the additional executable code in conjunction with the data, embedded executable code, or both.

5. The method of claim 4, wherein the additional executable code is selected based on data in the remote database.

6. The method of claim 1, wherein the electronic document is provided with a user input mechanism.

7. The method of claim 6, wherein the user input mechanism is a modal window capable of receiving input from the user.

8. The method of claim 6, wherein the user input mechanism includes a plurality of selectively editable fields.

9. The method of claim 1, further comprising using the executable code to collect information about the user, and using the collected information to modify the viewing experience.

10. The method of claim 9, wherein the collected information is an identifier associated with the user.

11. The method of claim 9, further comprising the step of sending the collected information to the remote database.

12. The method of claim 11, further comprising the additional step of updating the remote database with the collected information.

13. The method of claim 12, wherein the collected information includes an electronic document identifier and a user identifier.

14. The method of claim 12, wherein the collected information includes actions taken by a user with respect to the document.

15. The method of claim 1, wherein the electronic document is in Portable Document Format.

16. The method of claim 1, wherein the executable code is Javascript code.

17. The method of claim 1, wherein the executable code is Flash code.

18. The method of claim 1, wherein the viewing experience is altered by changing the appearance of the electronic document.

19. The method of claim 1, wherein the viewing experience is altered by providing an interactive module.

20. The method of claim 19, wherein the interactive module opens a new viewing window.

21. The method of claim 19, wherein the interactive module communicates user input to the remote database.

22. The method of claim 1, further comprising storing the data from the remote database on a computer that is displaying the viewing experience to the user.

23. A system comprising:
a remote database having data and executable code;
an electronic document having read-only content, having embedded executable code which executes upon opening the document, and the executable code influences a viewing experience using data from the database; and
a communications channel between the electronic document and the remote database, wherein the communications channel is capable of transmitting the data from the database to the document.

24. The system of claim 23, wherein the data includes actions taken by a user with respect to the document.

25. The system of claim 23, wherein the data includes actions taken by a user with respect to another document.

26. The system of claim 23, wherein the electronic document also has a user input mechanism.

27. The system of claim 26, wherein the user input mechanism is a modal window capable of receiving input from the user.

28. The system of claim 26, wherein the user input mechanism includes a plurality of selectively editable fields.

29. The system of claim 23, wherein the executable code also collects information about the user, and the executable code uses the collected information to modify the viewing experience.

30. The system of claim 29, wherein the collected information is context sensitive information.

31. The system of claim 29, wherein the collected information is an identifier associated with the user.

32. The system of claim 29, wherein the communications channel is also capable of transmitting the collected information to the remote database.

33. The system of claim 32, wherein the executable code is capable of sending the collected information to the remote database.

34. The system of claim 32, wherein the collected information includes actions taken by the user with respect to the document.

35. The system of claim 23, wherein the electronic document is in Portable Document Format.

36. The system of claim 23, wherein the executable code is Javascript code.

37. The system of claim 23, wherein the executable code is Flash code.

38. The system of claim 23, wherein the executable code is capable of altering the viewing experience by changing the appearance of the electronic document.

39. The system of claim 23, wherein the executable code is capable of altering the viewing experience by providing an interactive module.

40. The system of claim 39, wherein the interactive module opens in a new viewing window.

41. The system of claim 39, wherein the interactive module is capable of communicating user input to the remote database.

42. The system of claim 23, wherein the communications channel includes a local memory device for storing data from the remote database until the data is ready to be provided to the executable code.

43. The system of claim 23 further comprising additional executable code in the remote database, which may be provided to a local computer and executed to provide the viewing experience in conjunction with the data, the embedded executable code, or both.
